(19) United States
(12) Patent Application Publication
(10) Pub. No.: US 2008/0162614 A1
(43) Pub. Date: Jul. 3, 2008

(54) Apparatus, method and computer program product providing calendar application with automatic decision making for received invitation based on parameter sets

(75) Inventors: Jussi Hurmola, Tampere (FI); Sampo J. Savolainen, Espoo (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/646,756

(22) Filed: Dec. 28, 2006

(51) Int. Cl. G04G 11/00

(52) U.S. Cl. 708/112

(57) ABSTRACT

In one exemplary aspect the invention includes a method that operates by receiving an invitation to create a calendar event from an originating calendar application at a recipient calendar application, the invitation comprising at least one calendar event parameter; comparing by the recipient calendar application the at least one received calendar event parameter to a set of local calendar event parameters at the recipient calendar application and one of automatically replying with an acceptance of the invitation or a rejection of the invitation based on the comparison, where an acceptance of the invitation comprises creating a new calendar event in a user's calendar that is managed by the recipient calendar application.

### TECHNICAL FIELD

The exemplary embodiments of this invention relate generally to user interfaces for devices and methods pertaining to same and, more specifically, relate to calendar-type and similar scheduling-capable and time management applications.

### BACKGROUND

An automated calendar application is typically used in a manner similar to that of a traditional list of reminders written into a book or other paper medium. Decision making and simple tasks are all manually determined and added to the calendar. The calendar is based on singleton events which are communicated through some invitation-type of explanation of an event content and time of occurrence.

Time is a resource that everyone understands and has access to. In the modern information community the amount of data can easily swamp an individual, hindering the individual's work performance and enjoyment of personal life. Information arranging systems have traditionally concerned mostly the information external to the person. However, in the information era one's personal information, and the management of that personal information, becomes an important factor in a person's effectiveness and independence. A personal resource that is often underrated or totally overlooked is Time.

As is noted by A. Niemi (Nokia Research Center) in Internet-Draft: Session Initiation Protocol Event Packages for Calendering, draft-niemi-sipping-cal-events-01, expired Sep. 7, 2006, calendar sharing enables a user to subscribe to receiving information of a specific remote calendar. This calendar can represent the calendar entries of a particular user's daily schedule, or any other type of calendar information such as the release schedule of an open source software project. Niemi discusses several preexisting standards, and works in progress, in the area of calendaring. Most notably, the Internet Scheduling Core Object Specification (iCalendar), (see Dawson, F. and Stenerson, D., “Internet Calendaring and Scheduling Core Object Specification (iCalendar)”, RFC 2445, November 1998), the iCalendar Transport-Independent Interoperability Protocol (iTIP), (see Silverberg, S., Mansour, S., Dawson, F., and R. Hopson, “iCalendar Transport-Independent Interoperability Protocol (iTIP) Scheduling Events, BusyTime, To-dos and Journal Entries”, RFC 2446, November 1998), define the data format, and its binding to Internet email (see Dawson, F., Mansour, S., and S. Silverberg, “iCalendar Message-Based Interoperability Protocol (iMIP)”, RFC 2447, November 1998).

RFC 3265 (Roach, A., “Session Initiation Protocol (SIP)-Specific Event Notification”, Jun. 2002) defines an event subscription and notification framework that can be used to subscribe to different types of events related to SIP systems. A publication counterpart, defined in RFC 3903 (Niemi, A., “Session Initiation Protocol (SIP) Extension for Event State Publication”, RFC 3903, October 2004), allows for a SIP user agent to publish event state into a central compositor that then distributes this information to the subscribers of that event package.

The Niemi Internet draft (draft-niemi-sipping-cal-events-01) defines two new event packages for calendaring events; the first allows sharing of calendar events and the second enables scheduling events related to calendaring. Using these two event packages there is defined, in effect, an iTIP mapping to SIP.

Niemi defines several related concepts as follows: Calendar User Agent: a SIP user agent that acts on the behalf of the calendar user, Calendar Server: a SIP user agent responsible for accepting subscriptions and sending out notifications containing calendar data, Calendar Watcher: a SIP user agent responsible for issuing subscriptions and processing notifications of calendar events.

The background of calendar sharing and scheduling applications as summarized by Niemi as dating back several years. Especially in the enterprise domain, these applications have been commonplace for nearly a decade. Many enterprise collaboration tools have provided enterprise users with tools that enable calendar access, as well as the ability to schedule meetings and other calendar entries among the users.

Tools based on proprietary protocols have provided very little interoperability, and generally have not allowed inter-organizational calendar access. Being able to schedule meetings across organizations necessitates the availability of: interoperable data formats, interoperable sharing and scheduling protocols and reasonable means of access control and channel security.

The availability of the first is all but guaranteed at present. The iCalendar format and its predecessor, the vCalendar format (see Internet Mail Consortium, “vCalendar—The Electronic Calendaring and Scheduling Exchange Format”, http://www.imc.org/pdi/vcal-10.txt, September 1996) are nearly ubiquitous and supported currently by a majority of Personal Information Management (PIM) applications.

Some solutions for calendar sharing and scheduling have been available based on standard components, such as by being based on HTTP (see Fielding, R., Gettys, J., Mogul, J., Frystyk, H., Masinter, L., Leach, P., and T. Berners-Lee, “Hypertext Transfer Protocol-HTTP/1.1”, RFC 2616, June 1999) and WebDAV (see Goland, Y., Whitehead, E., Faizi, A., Carter, S., and D. Jensen, “HTTP Extensions for Distributed Authoring—WEBDAV”, RFC 2518, Febuary 1999) extensions. Recent efforts have proposed CalDAV as a standard calendar access protocol based on WebDAV. Extending calendaring applications beyond a single administrative domain requires that the protocols allow reasonable means for user identification, authentication and access control.

Parameters can be used to model calendar entries, such as when attempting to decide between two calendar applications whether a calendar invitation/entry should be approved, rejected or a modification suggested. However, these parameters can be numerous, and may be difficult to manage and set for a single event.

Time, importance and location are typically the only values currently available for use in a calendar entry, and currently available calendar applications do not perform an automatic handshake and acceptance.

Further, it can be the case that the user becomes overwhelmed by private, professional and other calendar invitations and cancellations, resulting in the calendar becoming full of vague or erroneous entries. Properly maintaining the calendar is a laborious manual task. While calendar invitations and cancellations can often be easily resolved by certain parameters about the user that the user has knowledge of, the calendar has no knowledge of these parameters (e.g., the user will not attend a meeting in Europe if he is in Canada). Presently available calendars do not have the capability to automatically determine whether to accept or reject a particular invitation.

In addition, currently available calendar systems allow only the sharing of the entire calendar, and confidentiality issues are resolved by defining multiple calendars, such as one for work, one for family, one for leisure time, one for sporting events and so forth. Calendar events are then inserted into one or multiple calendars.

The approach suggested by Niemi suggests that there be more that one calendar for a single user, and instead of defining the parameters in events, these would be divided between the plural calendars. This approach would not facilitate a situation where the user needs a specific calendar to divide between requests.

### SUMMARY OF THE EXEMPLARY EMBODIMENTS

The foregoing and other problems are overcome, and other advantages are realized, in accordance with the non-limiting and exemplary embodiments of this invention.

In accordance with the exemplary embodiments of this invention there is provided a method that includes receiving an invitation to create a calendar event from an originating calendar application at a recipient calendar application, the invitation comprising at least one calendar event parameter; comparing by the recipient calendar application the at least one received calendar event parameter to a set of local calendar event parameters at the recipient calendar application and one of automatically replying with an acceptance of the invitation or a rejection of the invitation based on the comparison, where an acceptance of the invitation comprises creating a new calendar event in a user's calendar that is managed by the recipient calendar application.

Further in accordance with the exemplary embodiments of this invention there is provided a computer program product that includes computer executable program instructions embodied in a tangible storage medium, where the execution of the instructions result in operations that comprise: receiving an invitation to create a calendar event from an originating calendar application at a recipient calendar application, the invitation comprising at least one calendar event parameter; comparing by the recipient calendar application the at least one received calendar event parameter to a set of local calendar event parameters at the recipient calendar application and one of automatically replying with an acceptance of the invitation or a rejection of the invitation based on the comparison, where an acceptance of the invitation comprises creating a new calendar event in a user's calendar that is managed by the recipient calendar application.

Further in accordance with the exemplary embodiments of this invention a device includes a user interface coupled to a first calendar application functional module configured to receive an invitation to create a calendar event from a second calendar application, the invitation comprising at least one calendar event parameter. The first calendar application functional module is further configured to compare the at least one received calendar event parameter to a set of locally stored calendar event parameters and, in response, to automatically reply with an acceptance of the invitation or a rejection of the invitation. In response to accepting the invitation the first calendar application functional module creates a new calendar event in a user's calendar.

### BRIEF DESCRIPTION OF THE DRAWINGS

The foregoing and other aspects of the teachings of this invention are made more evident in the following Detailed Description, when read in conjunction with the attached Drawing Figures, wherein:

FIG. 1 is a simplified block diagram an embodiment of a wireless communications system having devices that are suitable for practicing the exemplary embodiments of this invention.

FIG. 2 is a block diagram showing a calendar application and functional module configured in accordance with the exemplary embodiments of this invention.

FIG. 3 is a logic flow diagram that illustrates a method and the operation of a computer program product in accordance with the exemplary embodiments of this invention.

### DETAILED DESCRIPTION

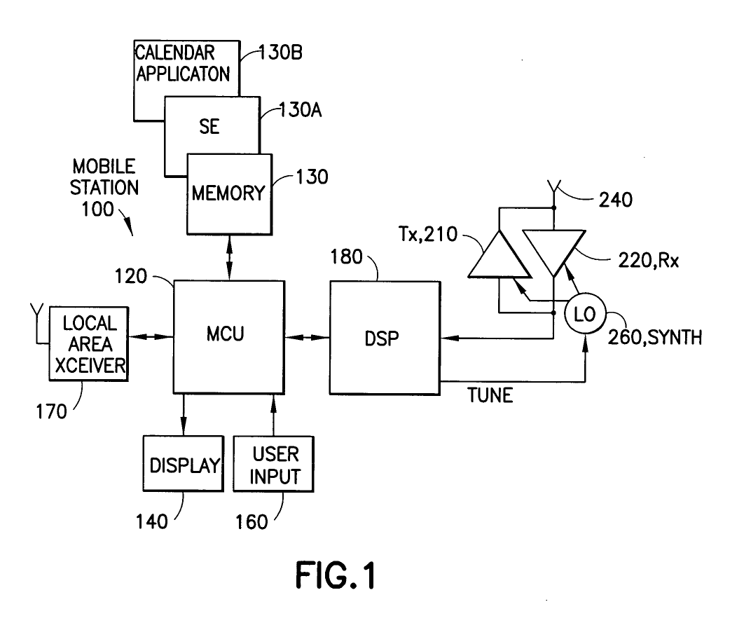

Referring to FIG. 1 there is shown as a simplified block diagram an embodiment of a device, such as a wireless communications device or mobile station 100, that is suitable for practicing the exemplary embodiments of this invention.

It should first be noted that while the exemplary embodiments of the invention will be shown and described as being practiced in a wireless communications terminal, in general the teachings of this invention apply to any type of electronic device that is capable of hosting a calendar/scheduling application software. Thus, the exemplary embodiments of this invention may be used in desktop computers and workstations, laptop computers, notebook computers and personal digital assistants (PDAs), to name just a few of the many possible devices that can benefit from the use of the exemplary embodiments of this invention. As such, it should be appreciated that the description of the MS 100 in FIG. 1 is not intended to be read in any way as a limitation upon the use and possible implementations of the exemplary embodiments of this invention.

Still referring to FIG. 1, the mobile station 100 typically includes a control unit or control logic, such as a microcontrol unit (MCU) 120 having an output coupled to an input of a display 140 and an input coupled to an output of a user input 160, such as a real or virtual keyboard or keypad and that may include some type of pointing device such as, but not limited to, a stylus, a mouse or a touch-sensitive display screen. The mobile station 100 may be a handheld radiotelephone, such as a cellular telephone or a personal communicator. The mobile station 100 could also be contained within a card or module that is connected during use to another device. For example, the mobile station 100 could be contained within a PCMCIA or similar type of card or module that is installed during use within a portable data processor, such as a laptop or notebook computer.

In general, the various embodiments of the MS 100 can include, but are not limited to, cellular telephones, personal digital assistants (PDAs) and portable computers, and may include or incorporate, as non-limiting examples, image capture devices such as digital cameras, gaming devices, music storage and playback appliances, Internet appliances permitting Internet access and browsing, as well as units or terminals that incorporate combinations of such fuinctions.

The MCU 120 is assumed to include or be coupled to some type of a memory 130, including a non-volatile memory for storing an operating program and other information, as well as a volatile memory for temporarily storing required data, scratchpad memory, received packet data, packet data to be transmitted, and the like. The operating program is assumed, for the purposes of this invention, to enable the MCU 120 to execute the software routines, layers and protocols required to implement the methods in accordance with the exemplary embodiments of this invention, as well as to provide a suitable user interface (UI), via display 140 and user input 160, with a user. Although not shown, a microphone and speaker may be provided for enabling the user to conduct voice calls in a conventional manner.

Stored in the memory 130 is assumed to be a data structure that is descriptive of at least one scheduled event (SE) 130A, such as meetings. The SE data structure 130A is established, managed and used in accordance with the exemplary embodiments of this invention. Associated with the SE 130A is a scheduled event application, which may be referred to for convenience as a calendar application 130B. The calendar application 130B comprises computer executable program code that interacts with the data structure that is descriptive of the SE 130A, and is suitable for use in implementing the exemplary embodiments of this invention, as described more fully below.

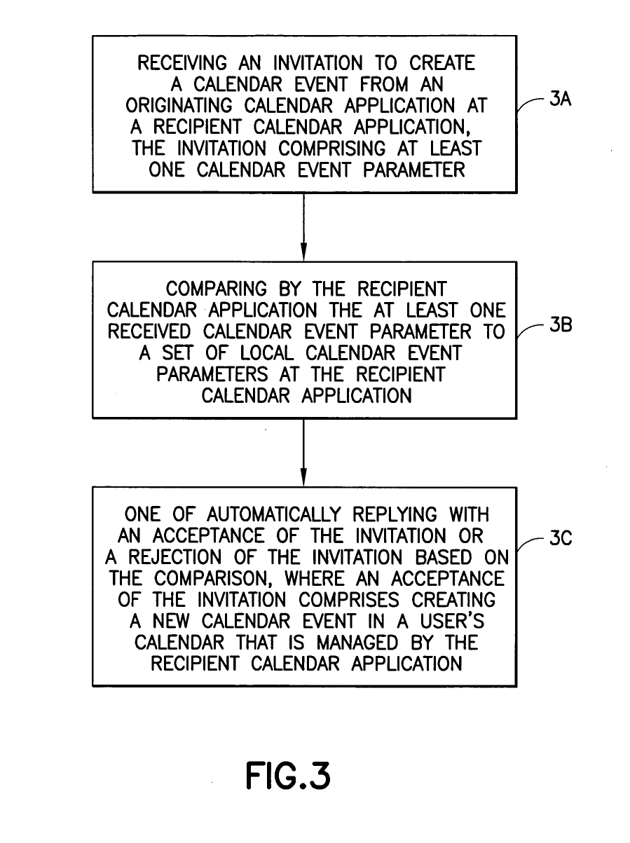

The mobile station 100 also typically contains a wireless section that includes a digital signal processor (DSP) 180, or equivalent high speed processor or logic, as well as a wireless transceiver that includes a transmitter 200 and a receiver 220, both of which are coupled to at least one antenna 240 for communication with a network operator. At least one local oscillator, such as a frequency synthesizer (SYNTH) 260, is provided for tuning the transceiver. Data, such as digitized voice and packet data, is transmitted and received through the antenna 240. The wireless section may be considered to function as a long range interface (e.g., hundreds or thousands of meters) to a base station coupled to a communications network, such as a cellular operator network and/or the Internet. Note that the MS may also include a local area wireless transceiver (Xceiver) 170, such as one based on Bluetooth™ low power RF or infrared (IR) technology. The local area transceiver 170 may be considered as a short range interface (e.g., meters or tens of meters) for coupling to a wireless local area network (WLAN) via a suitable access point. The exemplary embodiments of this invention may be implemented by computer software (e.g., the calendar application 130B) executable by a data processor of the mobile station 100, such as the processor 120, or by hardware, or by a combination of software and hardware. Further in this regard it should be noted that the various blocks of the logic flow diagram of, for example, FIG. 3 (described below) may represent program steps, or interconnected logic circuits, blocks and functions, or a combination of program steps and logic circuits, blocks and functions.

The memory 130 may be of any type suitable to the local technical environment and may be implemented using any suitable data storage technology, such as semiconductor-based memory devices, magnetic memory devices and systems, optical memory devices and systems, fixed memory and removable memory. The data processor(s) 120, 180 may be of any type suitable to the local technical environment, and may include one or more of general purpose computers, special purpose computers, microprocessors, digital signal processors (DSPs) and processors based on a multi-core processor architecture, as non-limiting examples.

In general, the various exemplary embodiments may be implemented in hardware or special purpose circuits, software, logic or any combination thereof. For example, some aspects of the exemplary embodiments of this invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

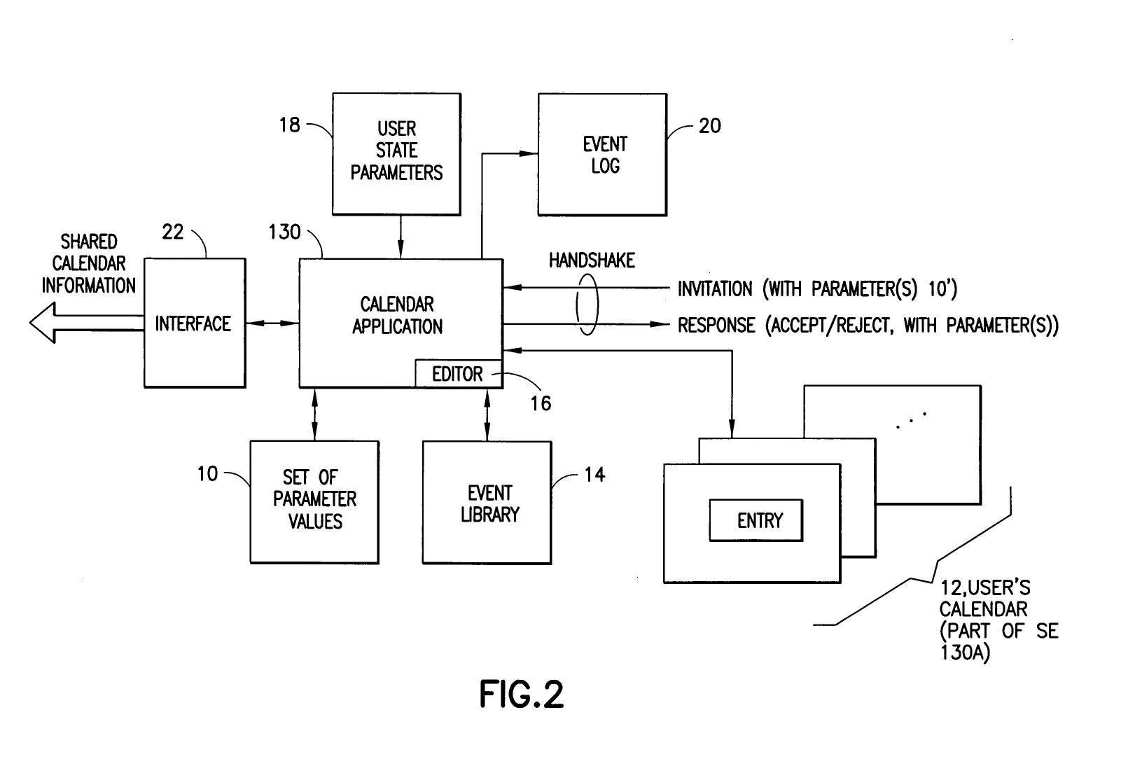

Referring to FIG. 2, and in accordance with exemplary embodiments of this invention, in order to automatically control, maintain and keep up-to-date the user's calendar 12 the calendar application 130B (which may be embodied in whole or in part as program code and/or in whole or in part as hardware, such as in the form of calendar application functional module) lists basic default entry types (set of parameter values 10) for events and enables template events to be defined using the user interface 140, 160. As an example, one parameter 10 may be set for the condition “sleeping”, where sleeping is defined to include the daily time span of 22:00→7:00, and which causes an automatic rejection of all or substantially all invitations for scheduling a calendar event during this period. Another exemplary parameter 10 may be “holiday”, which may be used to automatically cancel work related non-important invitations automatically for any dates defined for the holiday parameter. Cost may be used as a parameter 10, such as when a service provider, e.g., a dentist or hairdresser, sends an invitation for a scheduled treatment.

Work can be scheduled by template events. For example, the user may set a template preference for a physical meeting, as opposed to a telephone meeting, such that an invitation for a teleconference is automatically rejected, and instead an invitation for a face-to-face meeting is generated instead. The user. may also set a template preference for invitations for certain persons, and these can then be automatically scheduled. The user may also select one or more parameter sets 10 for events from an event library 14 associated with the calendar application 130B. For example, a tennis lesson may have locality, private time, cost and preferred teacher parameters that are pre-defined by the user and stored for later use.

The calendar application 130B thus includes the event library 14 and functionality to add events and use existing events as templates for new events. The calendar application 130B may include an editor 16 to enable the user to browse the event library 12 and to edit events and their parameters, as well as create new events, via the user interface 140, 160.

A particular calendar invitation contains all parameters of the event the invitation is made for. When the calendar application 130B receives an invitation it checks the invitation's parameters 10′ and the parameters 10 associated with a concurrent/adjacent meeting so as to automatically accept or reject the invitation. The calendar application 130B may send a rejection to the invitation, and the invitation rejection may include an explanation of the parameter or parameters which caused the rejection. Certain parameters may be designated by the user as private, in which case the rejection explanation will not include an indication of a parameter marked as private.

The transactions of receiving a calendar invitation and replying with one of an acceptance or a rejection may be considered to be a calendar handshake, or more simply as a handshake. In practice the handshake may occur through one or both of the long range transceiver 210, 220 and short range transceiver 170, and/or via a wired network or other type of connection.

Through the use of the exemplary embodiments of this invention the user does not have to specify all calendar event parameters 10, but instead may retrieve them from event library 14. That is, the calendar application 130B includes the modifiable set of parameters 10 with which an automated decision making process is invoked by the calendar application 130B upon receiving an invitation, where at least some of the parameters 10 may be obtained from the event library 14.

Further in accordance with the exemplary embodiments of this invention, the calendar application 130B automatically schedules incoming calendar entries/invitations using an intelligent decision making process based on the parameters 10 defined in the calendar event and the receiving user's calendar 12. This may be accomplished by defining the set of extendable local parameters 10 to be linked to an entry in the calendar 12 and to an invitation. The receiving calendar application 130B cross-checks the parameters 10′ in an incoming invitation with those parameters linked to or otherwise associated with at least one entry in the user's calendar 12, and automatically accepts the invitation if there is a match. The parameters 10, 10′ can have attributes such as negative or positive, and may have an associated importance value. When accepted, the calendar application 130B may automatically re-arrange one or more entries in the user's calendar 12, and may re-schedule or cancel an event or events conflicting with a newly approved calendar entry.

Therefore, in this embodiment there are a set of extendable parameters 10 that can be linked to the calendar entry/invitation. The incoming parameters 10′ are used if the receiving calendar application 130B understands the parameters. Any received parameters 10′ that are not recognized by both the receiving calendar application 130B and the sending calendar application 130B′ are not included in a handshake. The calendar applications 130B, 130B′ cross-check the parameters 10 and the calendar application 13OB receiving the invitation may accept the invitation only if all the parameters 10, 10′ match. As was noted above, the parameters 10, 10′ can be negative or positive and may have a value of importance. If a positively matching parameter conflicts with a negatively matching (non-matching) parameter, a decision can be based on the importance value of the conflicting parameters. The calendar application 130B may also have access to another set of parameters 18 describing the user's state or presence, such as the user's location (which may be derived from a suitable location determination system such as GPS), as well as possible interrupting states such as “do not disturb”. The calendar 12 and its various entries may be considered to be the sum of all events and their parameters. When an invitation is accepted the calendar application 130B is enabled to automatically re-arrange and re-schedule entries of the user's calendar 12, if needed, and may provide a notification to the user (via the user interface display 140) if some new deadline(s) requires it. The calendar application 130B may maintain an event log 20 so that the user can see the handshake transactions afterwards, or for use in monitoring them in real time or substantially real time.

These exemplary embodiments of this invention thus provide the calendar application 130B with means to function as an assistant to the user so as to automatically arrange the user's calendar 12. The calendar application 130B automatically accepts/rejects incoming invitations based on a two-way handshake that includes parameters 10 defined for the calendar 12 and parameters 10′ received with an incoming invitation.

Further in accordance with the exemplary embodiments of this invention, and as was noted above, currently available calendar systems allow only the sharing of the entire calendar, and confidentiality issues are resolved by defining multiple calendars. Calendar events are then inserted into one or multiple calendars. In general, there is no capability available to automate calendar management for, as an example, sport-related practice times, or to give full authority for a travel agent to add events into the user's calendar for scheduling a vacation week for multiple calendars. With conventional calendars systems busy/free information publishing is limited or non-existent.

Currently, electrical calendars may be synchronized to calendar server(s), and meetings may be requested from one electrical calendar to another. Further, an entire calendar may be shared, such as within a company, or to a chosen person, or in the internet. Also, some busy/free information may be shared.

Further in accordance with the exemplary embodiments of this invention an interface 22 may be provided for calendar management, which allows controlling visibility and access to insert new events into the calendar 12. The calendar owner is enabled to control what (time-wise, event-wise and to whom) information to share that is related to the user's calendar 12. Selected details may be published via the externally available interface 22 to selected persons (or computer systems). The selected person is then able to view, for example, all tasks needed to accomplish a task given to him. In practice the interface 22 may be coupled to one or both of the long range transceiver 210, 220 and short range transceiver 170, and/or to a wired network or other type of connection.

As one exemplary use case, the scheduling of a vacation week may be delegated to a travel agent. As another exemplary use case, a computerized agent of a tennis court is allowed to check busy/free information for a certain evening from the user's calendar, and to insert a tennis court reservation if that time fits the user's calendar as well as the calendar of the person with whom the user intends to play. In this latter case, assume that the user and the person who is to play tennis with the user are given access to the tennis court computer system, which then is enabled to view the user's busy/free information, along with other information such as if the user is or will be present in the particular city where the tennis court is located, and to then automatically insert a reservation for a certain date and time which fits the schedules of both the user and the person with whom the user will play. The reservation in this case may be sent as an invitation with parameters 10′, enabling the handshake to be performed as described above.

While a current standard (icalendar, itip, etc) may be utilized, additional access control is preferably implemented along with a definition of how to use the calendar information (e.g.,how calendar information is filtered, and how incoming requests are handled). It is within the scope these exemplary embodiments of the invention to use public key information (PKI) or similar techniques to accomplish authentication.

Through the use of these exemplary embodiments certain time consuming tasks (e.g., scheduling tasks) can be automated, and new business opportunities for time scheduling services are presented. Further, and again using the non-limiting example of the tennis court, the service provider is enabled to sell off peak or cancellation times with a discount, assuming the clients allow them to automatically search for free time in the client's calendar to propose a reservation.

Based on the foregoing it should be appreciated that non-limiting aspects of this invention relate to a method and to a computer program product to operate the calendar application 130B. As is shown in FIG. 3, the method and computer program product operate by receiving an invitation to create a calendar event from an originating calendar application at a recipient calendar application, the invitation comprising at least one calendar event parameter (Block 3A); comparing by the recipient calendar application the at least one received calendar event parameter to a set of local calendar event parameters at the recipient calendar application (Block 3B); and one of automatically replying with an acceptance of the invitation or a rejection of the invitation based on the comparison, where an acceptance of the invitation comprises creating a new calendar event in a user's calendar that is managed by the recipient calendar application (Block 3C).

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate. Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting embodiments a full and informative description of the invention. However, various modifications and adaptations may become apparent to those skilled in the relevant arts in view of the foregoing description, when read in conjunction with the accompanying drawings and the appended claims.

For example, while described above in at least one non-limiting example as the Calendar Application 130B displaying calendar-related information on the display 140, in other embodiments a remote display could be used, i.e., the calendar application and display need not be co-located in the same device or unit. Also, it should be realized that the exemplary embodiments of this invention can be used with any type of scheduled event, including meetings, concerts, dinner engagements and the like. However, all such and similar modifications of the teachings of this invention will still fall within the scope of this invention.

In addition, it is pointed out that while the exemplary embodiments of this invention have been primarily disclosed in the context of a mobile device (e.g., the MS 100), such as a mobile communication device, the exemplary embodiments may be employed as well in, as non-limiting examples, PC-based and web-based calendar applications. For example, a PC may initiate (or terminate) a mobile phone call (or an IP call, such as a VoIP call) on behalf of a user. That is, all of the exemplary embodiments described above may be embodied in any of a number of device types and systems, and are not intended to be limited in any way to any specific type of device or system.

Furthermore, some of the features of the exemplary embodiments of this invention may be used to advantage without the corresponding use of other features (e.g., the interface 22 may or may not be present in some embodiments). As such, the foregoing description should be considered as merely illustrative of the principles, teachings, examples and exemplary embodiments of this invention, and not in limitation thereof.

What is claimed is:

1. A method, comprising:
receiving an invitation to create a calendar event from an originating calendar application at a recipient calendar application, the invitation comprising at least one calendar event parameter;
comparing by the recipient calendar application the at least one received calendar event parameter to a set of local calendar event parameters at the recipient calendar application; and
one of automatically replying with an acceptance of the invitation or a rejection of the invitation based on the comparison, where an acceptance of the invitation comprises creating a new calendar event in a user's calendar that is managed by the recipient calendar application.

2. The method of claim 1, where replying with a rejection comprises selectively sending an indication of a calendar event parameter that resulted in the rejection back to the originating calendar application, where the indication is sent only if not designated as private by a user.

3. The method of claim 1, where the set of local calendar event parameters are obtained at least in part from an event library associated with the recipient calendar application.

4. The method of claim 1, where the at least one received calendar event parameter, and the local calendar event parameters comprise attributes that are considered during the step of comparing.

5. The method of claim 1, where at least one of the originating calendar application and the recipient calendar application are resident in a mobile device, and where communication between the originating and recipient calendar applications occurs at least in part through a wireless link.

6. The method of claim 1, where at least one of the originating calendar application and the recipient calendar application are resident in a mobile communication device, and where communication between the originating and recipient calendar applications occurs at least in part through one of a short range wireless link and a long range wireless link.

7. The method of claim 1, further comprising maintaining a log of invitation occurrences for review by the user.

8. The method of claim 1, where creating the new calendar event comprises one of re-scheduling or cancelling an existing calendar event.

9. The method of claim 1, further comprising selectively sharing calendar entries with a requesting application via an interface.

10. The method of claim 1, where comparing by the recipient calendar application further comprises comparing to a set of user state parameters.

11. A computer program product comprising computer executable program instructions embodied in a tangible storage medium, the execution of the instructions resulting in operations that comprise:
receiving an invitation to create a calendar event from an originating calendar application at a recipient calendar application, the invitation comprising at least one calendar event parameter;
comparing by the recipient calendar application the at least one received calendar event parameter to a set of local calendar event parameters at the recipient calendar application; and
one of automatically replying with an acceptance of the invitation or a rejection of the invitation based on the comparison, where an acceptance of the invitation comprises creating a new calendar event in a user's calendar that is managed by the recipient calendar application.

12. The computer program product of claim 11, where replying with a rejection comprises selectively sending an indication of a calendar event parameter that resulted in the rejection back to the originating calendar application, where the indication is sent only if not designated as private.

13. The computer program product of claim 11, where the set of local calendar event parameters are obtained at least in part from an event library associated with the recipient calendar application.

14. The computer program product of claim 11, where the at least one received calendar event parameter, and the local calendar event parameters comprise attributes that are considered during the step of comparing.

15. The computer program product of claim 11, embodied in a mobile communication device, and where communication between the originating and recipient calendar applications occurs at least in part through one of a short range wireless link and a long range wireless link.

16. The computer program product of claim 11, further comprising an operation of maintaining a log of invitation occurrences for review by the user.

17. The computer program product of claim 11, where creating the new calendar event comprises one of re-scheduling or cancelling an existing calendar event.

18. The computer program product of claim 11, further comprising an operation of selectively sharing calendar entries with a requesting application via an interface.

19. The computer program product of claim 11, where comparing by the recipient calendar application further comprises comparing to a set of user state parameters.

20. A device, comprising a user interface coupled to a first calendar application functional module configured to receive an invitation to create a calendar event from a second calendar application, the invitation comprising at least one calendar event parameter; said first calendar application functional module further configured to compare the at least one received calendar event parameter to a set of locally stored calendar event parameters and in response to automatically reply with an acceptance of the invitation or a rejection of the invitation, where in response to accepting the invitation said first calendar application functional module creates a new calendar event in a user's calendar.

21. The device of claim 20, where said first calendar application functional module, when replying with a rejection, is configured to selectively send an indication of a calendar event parameter that resulted in the rejection to the second calendar application, where the indication is sent only if not designated as private.

22. The device of claim 20, where the set of local calendar event parameters are obtained at least in part from an event library associated with the first calendar application functional module.

23. The device of claim 20, where the at least one received calendar event parameter, and the local calendar event parameters comprise attributes that are considered during the comparison.

24. The device of claim 20, comprising a mobile communication device that further comprises at least one of a short range wireless link and a long range wireless link, and where communication with the second calendar application occurs at least in part through one of the short range wireless link and the long range wireless link.

25. The device of claim 20, said first calendar application functional module further configured to maintain a log of invitation occurrences for review by the user using said user interface.

26. The device of claim 20, said first calendar application functional module further configured, when creating the new calendar event, to one of re-schedule or cancel an existing calendar event.

27. The device of claim 20, further comprising an interface to selectively share calendar entries with a requesting application.

28. The device of claim 20, said first calendar application functional module further configured to compare the at least one received calendar event parameter to a set of user state parameters.

29. The device of claim 20, where said first calendar application functional module is embodied at least in part in an integrated circuit.
